(19) United States
(12) Patent Application Publication
(10) Pub. No.: US 2001/0040207 A1
(43) Pub. Date: Nov. 15, 2001

(54) Portable display board system

(76) Inventor: James C. Richardson, Sharpsville, IN (US)

Correspondence Address: Bruce J. Bowman, Maginot, Addison & Moore, Bank One Center/Tower, 111 Monument Circle, Suite 3000, Indianapolis, IN, 46204-5115, US

(21) Appl. No.: 09/835,061

(22) Filed: Apr. 13, 2001

Related U.S. Application Data
(60) Provisional application No. 60/196,993, filed on Apr. 13, 2000.

(51) Int. Cl. A47B 97/04; F16M 11/38

(52) U.S. Cl. 248/460; 248/172

(57) ABSTRACT

A portable display or corporate board has a collapsible presentation surface that is supported by length adjustable legs. The display board also includes an integral handle. The display board has a first panel that is attached to a second panel such that the first and second panels form an essentially contiguous and continuous presentation surface when the first and second panels are in an extended, presentation, or open position. In a closed position, the first and second panels abut one another. The presentation surface may be any writing surface such as dry-erase, chalk, or otherwise. The length adjustable legs may constitute a tripod of telescoping rods pivotally attached to one of the first and second panels.

This application claims the benefit of U.S. Provisional Patent Application serial No. 60/196,993 filed Apr. 13, 2000, entitled Hand Held Briefcase Display or Corporate Board.

### FIELD OF THE INVENTION

The present invention relates generally to display boards and, more particularly, to a foldable and portable display and/or writing board system.

### DESCRIPTION OF THE PRIOR ART

There are many types of display boards that may be used for presentations such as dry-erase or “white” boards, chalkboards, and/or the like. However, heretofore designed display boards are difficult to move from location to location. This is particularly true if the board must be carried onto an airplane or placed into an automobile. A primary reason for this is the size of a typical display board.

In view of the above, various display boards have been designed that are collapsible or foldable. To this end, these previous display boards typically have a plurality of hinged panels that can fold together in order to alleviate the size problem. Some of these display boards include a handle that allows the display board to be portable. A major drawback with these type of display boards is that they are designed for table top use only, or must be used in conjunction with an easel or the like. The easel poses another problem, namely, having to carry another piece of equipment with the display board.

Another problem with previous display boards is that there is little to no writing surface. Most previous display boards are adapted to receive pictures, charts and the like mounted thereon. When there is a writing surface, a small board or portion of a board is provided. These display boards fall short in cases where it is necessary to have a large writing area.

Yet another problem with the above-referenced display boards and other types of display boards, is that they are either too light, being made of cardboard or similar material, or are too heavy.

In view of the above shortcomings, it would thus be desirable to have a portable display board that is height adjustable using its own height adjustment mechanism.

Given the above, it would thus be further desirable to have a portable display board that has a large writing surface.

Still given the above, it would thus be even further desirable to have a display board that incorporate features that alleviates all of the above shortcomings/problems associated with previous display boards.

### SUMMARY OF THE INVENTION

The present invention is a portable display board. The portable display board includes an integral height adjustable stand, carrying handle, and two panels that are connected to one another so as to form an essentially continuous and/or contiguous presentation surface when in an open position.

In one form, the present invention is a display board having a first panel, a second panel, a handle, and a set of length adjustable legs. The first and second panels each have a presentation side and a non-presentation side. The first and second panels are pivotally attached to one another such that the first and second panels are selectively positionable into first and second positions, wherein when the first and second panels are in the first position, one of the sides of the first panel abuts one of the sides of the second panel, and wherein when the first and second panels are in the second position, the presentation side of the first panel forms a contiguous presentation surface with the presentation side of the second panel. Further, the handle is attached to one of the first and second panels, while the set of length adjustable legs are pivotally attached to the non-presentation side of the first panel.

In another form, the present invention is a portable writing board that includes a first board having a writing surface on a first side thereof, and a second board having a writing surface on a first side thereof. The first and second boards are pivotally coupled to each other and selectively positionable in and between an open configuration and a closed configuration, wherein when the first and second boards are in the open configuration the writing surface on a first side of the first board and the writing surface on a first side of the second board contiguously meet at mutual edges thereof forming a substantially continuous writing presentation surface, and when the first and second boards are in a closed position, the writing surface on a first side of the first board abuts the writing surface on a first side of the second board. The portable writing board also includes a height adjustable stand mounted to a second side of the first board, and a handle coupled to one of the first and second boards.

In yet another form, the present invention is a transportable corporate board. The transportable corporate board includes a first panel and a second panel, with the first and second panels hingedly coupled to one another at a mutual edge thereof. The first panel defines a first writing surface while the second panel defines a second writing surface. The first and second panels are selectively positionable into a presentation configuration and a closed position, wherein when the first and second panels are in the presentation position the first writing surface is contiguous and coplanar with the second writing surface together defining a presentation surface, and when the first and second panels are in the closed position the first writing surface abuts the second writing surface. The transportable corporate board further includes a handle coupled to one of the first and second panels, and a plurality of height adjustable legs attached to one of the first and second panels at a rear surface thereof opposite the respective first and second writing surfaces.

### BRIEF DESCRIPTION OF THE DRAWINGS

The above-mentioned and other features and advantages of this invention, and the manner of attaining them, will become more apparent and the invention will be better understood by reference to the following descriptions of embodiments of the invention taken in conjunction with the accompanying drawings, wherein:

FIG. 1 is a front plan view of an embodiment of a portable display board system in accordance with the principles of the present invention in a closed, collapsed, or folded state;

FIG. 2 is a rear plan view of the portable display board system of FIG. 1 in the closed, collapsed, or folded state;

FIG. 3 is a side plan view of the portable display board system of FIGS. 1 and 2 in the closed, collapsed, or folded state;

FIG. 4 is a front perspective view of the portable display board system of FIGS. 1-3 in an open and extended position;

FIG. 5 is a side view of the portable display board system of FIGS. 1-4 illustrating the manner in which the display board extends;

FIG. 6 is a rear plan view of another embodiment of the present portable display board showing one set of extendable legs in an extended position and the board in an open position;

FIG. 7 is a plan view of the one set of extendable legs;

FIG. 8 is a front plan view of the embodiment of FIG. 6, with the board in an open position but no legs extended;

FIG. 9 is a side view of the present portable display board taken along line 9-9 of FIG. 8;

FIG. 10 is a plan view of an outside surface of one panel of the portable display board of FIG. 6;

FIG. 11 is a side view of the panel of FIG. 10 taken along line 11-11 of FIG. 10;

FIG. 12 is a plan view of an inside surface of the panel of the portable display board of FIG. 10;

FIG. 13 is a side view of the portable display board of FIG. 12 taken along line 13-13 of FIG. 12;

FIG. 14 is a bottom perspective view of the portable display board of FIG. 6 with the extendable legs in a closed or collapsed position;

FIG. 15 is a bottom perspective view of the portable display board of FIG. 6 with the extendable legs in an extended position; and

FIG. 16 is a bottom perspective view of the portable display board of FIG. 6 with the extendable legs in an extended and open position.

Corresponding reference characters indicate corresponding parts throughout the several views.

### DETAILED DESCRIPTION

While the invention is susceptible to various modifications and alternative forms, the specific embodiment(s) shown and/or described herein is by way of example. It should thus be appreciated that there is no intent to limit the invention to the particular form disclosed, as the intention is to cover all modifications, equivalents, and alternatives falling within the spirit and scope of the invention as defined by the appended claims.

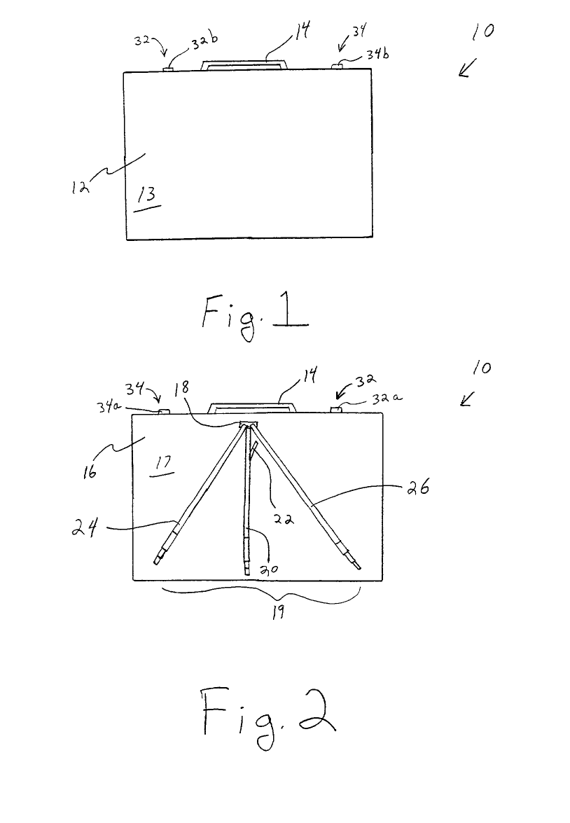

In FIGS. 1 and 2 there is shown an exemplary embodiment of a portable display or corporate board, generally designated 10, per the principles presented herein. The portable display board 10 includes a first panel or board 12 and a second panel or board 16. The panels 12 and 16 are preferably the same size and composition, but may vary in size and/or composition. The outside surface 13 of the panel 12 may be covered with a leather, vinyl, or similar aesthetically pleasing and/or durable material, particularly to look like a briefcase or the like when the display board 10 is carried. Likewise, the outside surface 17 of the panel 16 may be preferably covered with a leather, vinyl, or similar aesthetically pleasing and/or durable material, for the same reasons as for the outside surface 13 of the panel 12.

A set of length adjustable legs 19 is provided on the outside surface 17 of the panel 16 that provide a height adjustment mechanism for the first and second panels 12 and 16. The set of length adjustable legs 19 is attached to the outside surface 17 via a bracket 18. The bracket 18 may provide for one, some or all of the legs 19 to pivot in some manner with respect to the panel 17. Pivoting may include motion away from the outside surface 17 in a perpendicular direction relative to the outside surface 17 and/or motion along the outside surface 17 in a coplanar direction relative to the outside surface 17. In the embodiment shown, three legs, 20, 24, and 26 forms the set of length adjustable legs 19, each of which is formed of a plurality of telescoping rods. The telescoping rods are length adjustable into an infinite number of selectable positions of course, other manners of adjustable legs may be used. The legs 20, 24 and 26 form a tripod with the center leg 20 operative to rotate, swing, or pivot outward from the outside surface 17, and the outside legs 24 and 26 operative to rotate, swing, or pivot along or essentially coplanar with the outside surface 17. Again, other configurations of legs that provides a stable platform for allowing the display board 10 to freely stand.

It should be appreciated that the set of adjustable legs 19 may be formed by any number of individually adjustable legs, in any configuration, that allow the display board 10 to be free standing such as that shown in FIG. 4. As well, the legs forming the set of length adjustable legs 19 may utilize a manner of adjustment other than by interconnected, telescoping rods as indicated above. As shown in FIG. 2, it is preferable that the set of adjustable legs 19 collapse or reduce in length such that the individual legs do not extend beyond the ends or edges of the panel 16 when the display board 10 is in a carrying or transportation mode. Clamps or clips may be provided on the outside surface 17 to help retain the legs when not in use.

The display board 10 also includes a handle 14 disposed on an upper end or edge of the panel 16. It should be appreciated that while the handle 14 is shown on the panel 16, it can be disposed on an upper end or edge of the panel 12, or any edge or end of either board. The display board 10 further includes a first clasp or latch generally designated 32 having two components 32a and 32b that are disposed on the ends of the respective panels 16 and 12. The display board 10 also includes a second clasp or latch generally designated 34 having two components 34a and 34b that are disposed on the ends of the respective panels 16 and 12. It should be appreciated that there may be only one clasp or latch, that the clasp or latch may be formed by a single piece or more than two pieces, and that various types of devices are operative and contemplated to perform clasping or latching of the two panels 12 and 16 together in a face-to-face relationship. The clasp(s) aid in retaining the panels 12 and 16 together (abutting) or in a side-to-side relationship when the display board is in a collapsed or folded state as depicted in FIGS. 1-3.

To this end, the panels 12 and 16 are joined or attached to one another at complementary ends thereof, as best seen in FIG. 3, in a manner that allows the panels 12 and 16 to move, swing, or pivot relative to one another. Referring to FIG. 3, the panels 12 and 16 may be attached via a hinge 30 or other device that allows the panels 12 and 16 to pivot or move relative to the other. In particular, the panels 12 and 16 are attached to one another such that the panels 12 and 16 define and are movable between an extended/opened position and a collapsed/folded position. In FIGS. 1-3, the display board 10 is shown in a folded, collapsed, or carrying position or state.

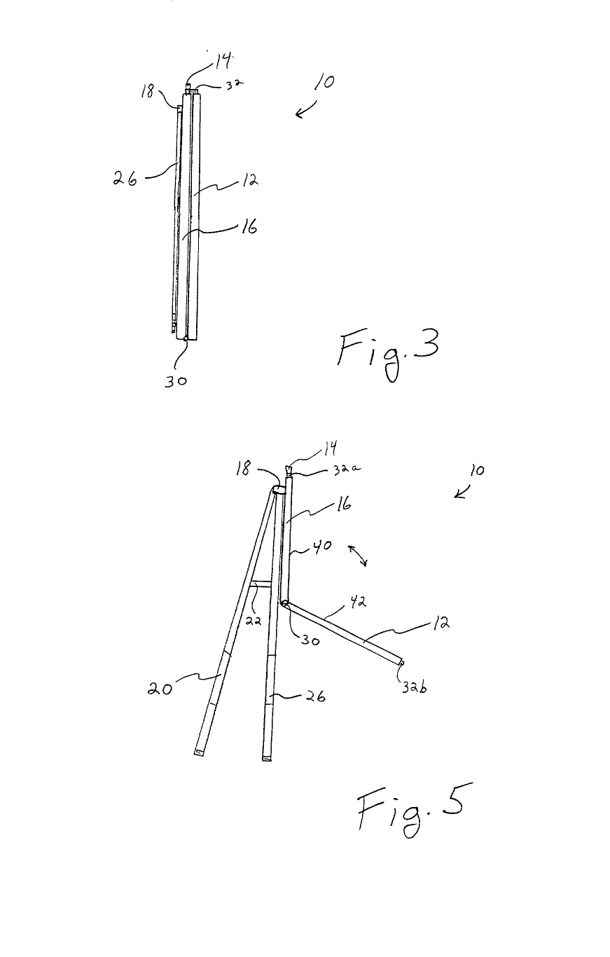

In FIG. 5, the legs 20, 26, and 24 (not seen) are extended in a tripod configuration with an extension 22 extending from the leg 20 and the outside surface 17 for support, such that the display board 10 may freely stand and the panels 12 and 16 may be opened. In FIG. 5, the panels 12 and 16 are shown being opened from the closed or collapsed position (as in FIGS. 1-3) as represented by the two-headed arrow, into a fully open position (see FIG. 4).

In FIG. 4, the portable display board 10 is shown in a fully open and extended position. In particular, the legs 24 and 26 are extended downwardly a given distance to set the height of the panels 12 and 16, while the hinged/middle leg 20 is likewise extended downwardly a given distance and pivoted outwardly to form the tripod. The panel 16 also defines a presentation side or surface 40 that are opposite the outside surface 17, while the panel 12 also defines a presentation side or surface 42 that is opposite the outside surface 13. The presentation sides may comprise a writing surface such as a “white” or dry-erase board, a chalkboard, or any other type of surface on which one may write and, preferably, erase. The presentation sides may be magnetic and/or may alternatively comprise another type of display and/or presentation surface.

When the panel 12 is pivoted downward such that the writing surface 42 is exposed, the writing surface 40 of the panel 16 is also exposed. In particular, an edge of the panel 12 that is attached to the hinge 30 and the edge of the panel 16 that is attached to the hinge 30 abuts one another such that the writing surfaces 40 and 42 form a continuous or contiguous presentation and/or writing surface. In this manner, the presentation or writing surface is doubled over conventional “one-panel” devices.

Because the stand (i.e. the set of adjustable legs 19) of the display board 10 is integral with or attached to the panel 16, the handle 14 can not only be used to transport the display board 10 when it is in a folded or collapsed state or position as in FIGS. 1-3, but can be used to carry the display board 10 when it is in an open or extended state or position as in FIG. 4.

FIG. 4 also shows an optional supply holder 50 formed as a pouch or pocket. The holder 50 holds several markers, erasers, and the like (collectively, “board tools”) for writing on the writing surfaces 40 and 42 of boards 16 and 12. The pocket 50 is designed to hold the board tools even when the display board 10 is in the folded or collapsed state ready for transporting or carrying.

Referring now to FIG. 6, there is shown another embodiment of the present portable display or corporate board, generally designated 100. The display board 100 is a modular version that is preferably manufactured from plastic such as an injection-molded plastic. In particular, the display board 100 includes a body 102 defined by a first panel 104 and a second panel 106, here shown in an open position with the rears thereof facing outward. The first panel 104 includes a handle portion 108 that is integral therewith. The second panel 106 includes a handle portion 110 that is integral herewith. The handle portions 108 and 110 cooperate when the first and second panels 104, 106 are in a closed position to provide an integral carrying handle for the display board 100.

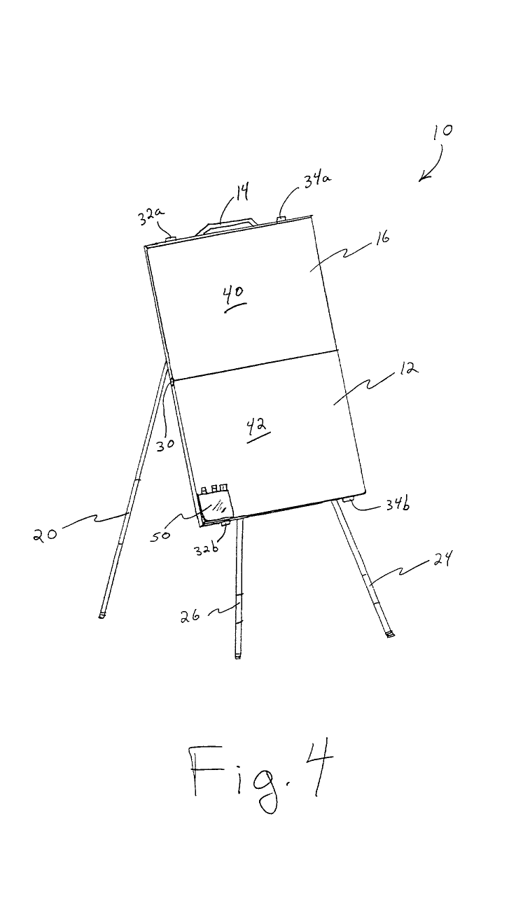

The display board 100 further includes an extendable stand 112 that is partially seated in a channel 114 in the second panel 106. Referring additionally to FIG. 7, the extendable stand 112 is formed of a first U-shaped rod or member 116 that is disposed in the channel 114. A rod 118 of a slightly smaller diameter than the U-shaped rod 116 is disposed in one “arm” of the U-shaped rod 116 such that the rod 118 can slide or telescope into the arm of the U-shaped rod 116. A rod 122 of a slightly smaller diameter than the rod 118 is disposed in the rod 118. The rod 122 can thus slide or telescope into the rod 118. In like manner, a rod 120 of a slightly smaller diameter than the U-shaped rod 116 is disposed in another “arm” of the U-shaped rod 116 such that the rod 120 can slide or telescope into the arm of the U-shaped rod 116. A rod 124 of a slightly smaller diameter than the rod 120 is disposed in the rod 120. The rod 124 can thus slide or telescope into the rod 120. Further, a second U-shaped rod or member 126 has first and second arms of a smaller diameter than rods 122 and 124 that fit into the rods 122 and 124 such that the U-shaped rod 126 can slide or telescope into the rods 122 and 124. The U-shaped rod 126 provides a support surface for the display board 100 and is pivotal with respect to the panel 106.

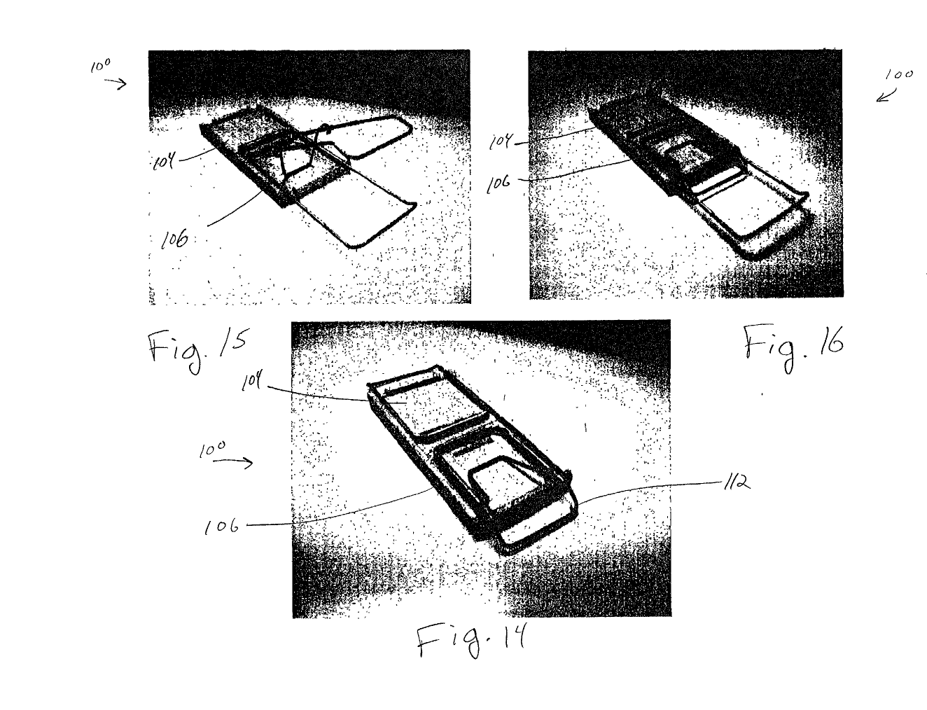

While not specifically shown in FIGS. 6 and 7, the display board 100 preferably includes a second extendable stand (see FIGS. 14-16) that is substantially the same in configuration and operation as the first extendable stand 112. The second extendable stand fits into and is retained by the first panel 104 in the same manner as the first extendable stand 112 fits into and is retained by the second panel 106.

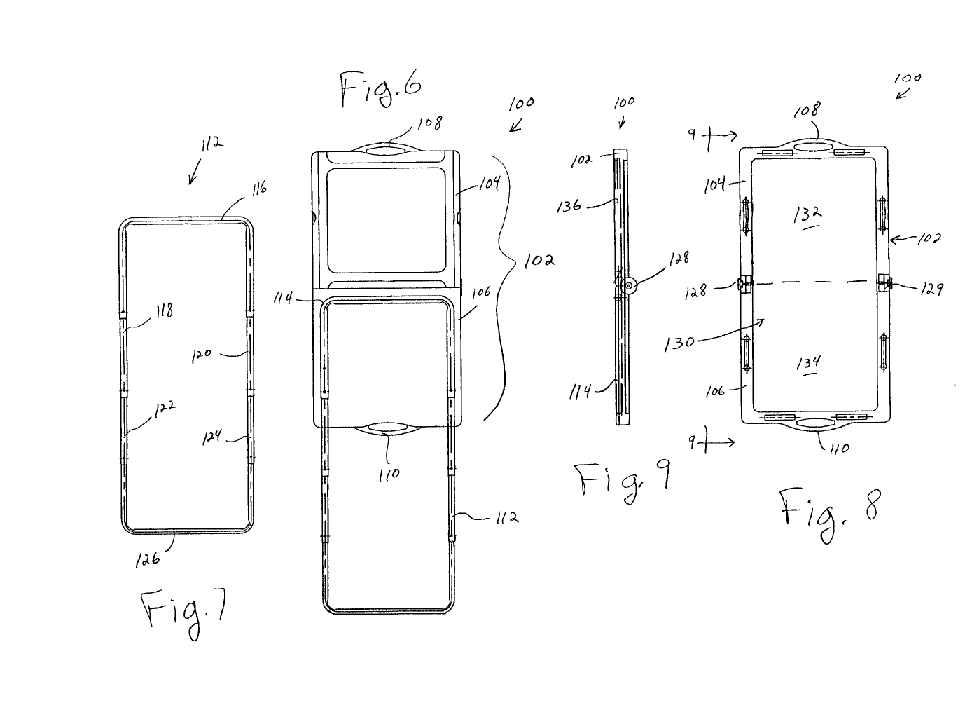

In FIGS. 8 and 9 the display board 100 is shown in an open position. The first panel 102 includes a writing or display surface 132, while the second panel 106 includes a writing or display surface 134. Together, the writing surfaces 132 and 134 define a contiguous and/or continuous writing surface 130 that is integral with or part of the body 102. The first panel 104 and the second panel 106 are pivotally coupled to one another via hinges 128 and 129 such that the panels 104 and 106 can selectively be in a first or open position as depicted in FIG. 8, or in a second or closed position wherein the writing surfaces 132 and 134 are abutting. As best seen in FIG. 9, the first panel 104 includes a channel 136 for the second extendable stand (not shown).

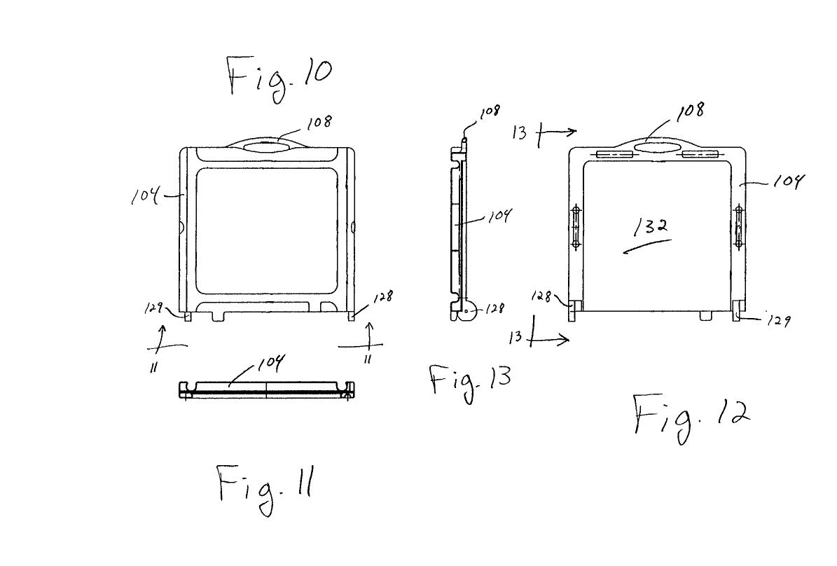

Referring to FIGS. 10-13, there is shown the first panel 104. The first panel 104 is preferably made of a suitable plastic such as an injection-molded plastic, or any other suitable material. The writing surface 132 is preferably a dry or wet erase marker type board, a “white” board, chalkboard, and/or any other suitable surface for writing on and, preferably erasing.

FIGS. 14-16 shows the rear of the display board 100, with the body 102 in an open position. It should be appreciated that the display board 100 is also moveable into a closed position wherein the panels 104 and 106 close on or abut each other and the extendable stands are collapsed into their respective panels. In particular, FIG. 14 shows the extendable stands for both the first panel 104 and the second panel 106 (wherein the extendable stand 112 thereof is labeled) in a closed or retracted (collapsed) position. FIG. 16 shows both of the extendable stands in an open or extended position, while FIG. 15 shows the extended stands in an open display position, wherein the extended stands are spread away from each other and a middle support bar is positioned therebetween. The middle support bar provides stability for the extendable stands/display board in general.

Because of the extendable stand structure, configuration, pivoting manner, and/or placement thereof, the display board 100 may be used with either end up or down. Additionally, the extendable stand structure allows the display board to be in varying degrees of angles. Further, the display board is height adjustable.

While this invention has been described as having a preferred design and/or configuration, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the claims.

What is claimed is:

1. A display board comprising:
a first panel having a presentation side and a non-presentation side;
a second panel having a presentation side and a non-presentation side;
a handle attached to one of said first and second panels;
a set of length adjustable legs pivotally attached to said non-presentation side of said first panel; and
said first and second panels pivotally attached to one another such that said first and second panels are selectively positionable into first and second positions, wherein when said first and second panels are in said first position one of said sides of said first panel abuts one of said sides of said second panel, and wherein when said first and second panels are in said second position said presentation side of said first panel forms a contiguous presentation surface with said presentation side of said second panel.

2. The display board of claim 1, further comprising a latch having a first latch component attached to said first panel and a second latch component attached to said second panel, said latch operative to releasably retain said first and second panels in said first position.

3. The display board of claim 1, wherein said first and second presentation surfaces each comprises a writing surface.

4. The display board of claim 3, wherein said writing surfaces are one of a chalkboard and a dry-erase board.

5. The display board of claim 1, wherein said set of length adjustable legs comprise an extendable and collapsible tripod arrangement of length adjustable legs.

6. The display board of claim 1, wherein said set of length adjustable legs comprises:
a pair of telescoping legs attached to said first non-presentation side of said first panel;
a fist telescoping leg pivotally attached to said first non-presentation side of said first panel between said pair of telescoping legs; and
wherein said first telescoping leg is operative to form a tripod with said pair of telescoping legs when said first telescoping leg and said pair of telescoping legs are in an open position.

7. The display board of claim 1, further comprising an accessory pocket disposed on one of said presentation sides.

8. The display board of claim 1, wherein said non-presentation sides are covered in one of leather, a synthetic material, and a combination of leather and synthetic material.

9. A portable writing board comprising:
a first board having a writing surface on a first side thereof;
a second board having a writing surface on a first side thereof;
said first and second boards pivotally coupled to each other and selectively positionable in and between an open configuration and a closed configuration, wherein when said first and second boards are in said open configuration said writing surface on a first side of said first board and said writing surface on a first side of said second board contiguously meet at mutual edges thereof forming a substantially continuous writing presentation surface, and when said first and second boards are in a closed position, said writing surface on a first side of said first board abuts said writing surface on a first side of said second board;
a height adjustable stand mounted to a second side of said first board; and
a handle coupled to one of said first and second boards.

10. The portable writing board of claim 9, further comprising:
a clasp having a first clasp component attached to said first board and a second clasp component attached to said second board, said clasp operative to releasably retain said first and second boards in the closed position.

11. The portable writing board of claim 10, further comprising:
a second clasp having a first clasp component attached to said first board and a second clasp component attached to said second board, said second clasp operative to releasably retain said first and second boards in the closed position.

12. The portable writing board of claim 9, wherein said writing surfaces comprise one of a dry-erase surface and a chalkboard surface.

13. The portable writing board of claim 9, wherein said height adjustable stand comprises a plurality of height adjustable legs pivotally attached to said second side of said first board.

14. The portable writing board of claim 13, wherein said plurality of height adjustable legs forms a tripod.

15. The portable writing board of claim 14, wherein said plurality of height adjustable legs are each formed of a plurality of telescoping rods.

16. The portable writing board of claim 9, wherein said handle is disposed on an edge of said first or second board opposite to where said first and second boards are coupled to one another.

17. A transportable corporate board comprising:
a first panel;
a second panel;
said first and second panels hingedly coupled to one another at a mutual edge thereof;
said first panel defining a first writing surface;
said second panel defining a second writing surface;
said first and second panels selectively positionable into a presentation configuration and a closed position, wherein when said first and second panels are in said presentation position said first writing surface is contiguous and coplanar with said second writing surface together defining a presentation surface, and when said first and second panels are in said closed position said first writing surface abuts said second writing surface;
a handle coupled to one of said first and second panels; and
a plurality of height adjustable legs attached to one of said first and second panels at a rear surface thereof opposite the respective first and second writing surfaces.

18. The transportable corporate board of claim 17, wherein said plurality of height adjustable legs are pivotally attached.

19. The transportable corporate board of claim 18, wherein said plurality of height adjustable legs are each formed of a plurality of telescoping rods and define a tripod.

20. The transportable corporate board of claim 17, further comprising a first clasp disposed on one side of mutual edges of said first and second panels, and a second clasp disposed on another side of said mutual edges of said first and second panels, said first and second clasps each having a first clasp component attached to said first board and a second clasp component attached to said second board, each said first and second clasps operative to releasably retain said first and second boards in said closed position.
